(19) United States
(12) Patent Application Publication
(10) Pub. No.: US 2023/0139718 A1
(43) Pub. Date: May 4, 2023

(54) AUTOMATED DATASET DRIFT DETECTION

(71) Applicant: Oracle International Corporation, Redwood Shores, CA (US)

(72) Inventors: Mojtaba Valipour, Waterloo (CA); Yasha Pushak, Vancouver (CA); Robert Harlow, Madison, WI (US); Hesam Fathi Moghadam, Sunnyvale, CA (US); Sungpack Hong, Palo Alto, CA (US); Hassan Chafi, San Mateo, CA (US)

(21) Appl. No.: 17/513,760

(22) Filed: Oct. 28, 2021

(51) Int. Cl. G06N 20/00; G06F 16/28

(52) U.S. Cl. CPC G06N 20/00; G06F 16/285

(57) ABSTRACT

Herein are acceleration and increased reliability based on classification and scoring techniques for machine learning that compare two similar datasets of different ages to detect data drift without a predefined drift threshold. Various subsets are randomly sampled from the datasets. The subsets are combined in various ways to generate subsets of various age mixtures. In an embodiment, ages are permuted and drift is detected based on whether or not fitness scores indicate that an age binary classifier is confused. In an embodiment, an anomaly detector measures outlier scores of two subsets of different age mixtures. Drift is detected when the outlier scores diverge. In a two-arm bandit embodiment, iterations randomly alternate between both datasets based on respective probabilities that are adjusted by a bandit reward based on outlier scores from an anomaly detector. Drift is detected based on the probability of the younger dataset.

### FIELD OF THE INVENTION

The present invention relates to data drift detection for machine learning. Herein are classification and scoring techniques that compare two similar datasets of different ages to detect data drift without a predefined threshold.

### BACKGROUND

Machine learning approaches typically assume that train and test data are independently and identically distributed (IID) such that both train and test datasets must contain similar data. After training may be production inferencing by a machine learning model. Although production data may initially resemble training data, eventually values in the production data may significantly diverge from the training data. This divergence of datasets is known as data drift, dataset drift, or concept drift. Data drift decreases inference accuracy. Detection of data drift may be difficult, unreliable, or costly.

In cases where dataset drift detection is unavailable, it is generally safer to periodically retrain a machine learning model on newly obtained data as a precaution to guard against the effects of data drift, regardless of whether or not drift is imminent. Such precautionary retraining is expensive and slow. Optimal retraining periodicity may be unknown, and safety favors too frequently retraining, which increases the expense of retraining.

Even when drift detection is available, there are numerous technical constraints and problems that may cause drift detection to be inaccurate (i.e. false positives and/or negatives) or unportable. For example, useful drift detection may be limited to particular details such as a particular dataset, particular features in the dataset, a particular target machine learning model or algorithm such as a neural network, and/or a particular functionality of a machine learning model such as classification. When any of those details are changed or unknown, drift detection may fail. In some cases, drift detection may rely on slow, error prone, and expensive human expertise such as sample labeling or threshold calibration.

### BRIEF DESCRIPTION OF THE DRAWINGS

In the drawings:

FIG. 1 is a block diagram that depicts an example computer that applies machine learning (ML) techniques to compare tuple sets of different respective ages to detect data drift without a predefined threshold;

FIG. 2 is a flow diagram that depicts an example computer process that applies ML techniques to compare tuple sets of different respective ages to detect data drift without a predefined threshold;

FIG. 3 is a block diagram that depicts an example computer that applies ML techniques to compare tuple sets of different respective ages to detect data drift;

FIG. 4 is a flow diagram that depicts an example computer process that applies ML techniques to compare tuple sets of different respective ages to detect data drift;

FIG. 5 is a block diagram that depicts an example computer that applies ML techniques to compare tuple sets of different respective ages to detect data drift;

FIG. 6 is a flow diagram that depicts an example computer process that applies ML techniques to compare tuple sets of different respective ages to detect data drift;

FIG. 7 is a block diagram that illustrates a computer system upon which an embodiment of the invention may be implemented;

FIG. 8 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Herein are classification and scoring techniques for machine learning that compare two similar datasets of different ages to detect data drift without a predefined drift threshold. One approach herein is based on a binary classifier and permutation. Other approaches herein are based on an anomaly detector and/or a bandit. These new approaches provide robust ways to automatically determine whether or not two datasets contain data with similar distributions. Compared to existing solutions, these new approaches: a) are sensitive to more kinds of dataset drift and b) automatically identify a good decision threshold that works well in all applications.

The classifier approach detects a similarity of two input distributions. Efficiency, flexibility, and convenience of this approach is based on a permutation test to estimate a distribution of a test statistic under a null hypothesis that drift supposedly has not occurred because two datasets supposedly have a same values distribution. This eliminates a prerequisite of other approaches that errors are binomially distributed and improves the accuracy of the drift test. For any input tuple, the binary classifier can somewhat accurately infer which of two datasets provided the tuple.

Intuitively, if the classifier’s performance is nearly random, then the two datasets are not distinguishable, and therefore are likely drawn from the same distribution. On the other hand, if the classifier is sufficiently accurate, then it is likely that the two datasets have different distributions. However, merely evaluating the performance of the classifier may be technically challenging without techniques herein.

A goal is to automatically identify a good drift threshold for two given datasets and a given classifier without the need to make any assumptions about the distribution of the test statistic under the null hypothesis. Herein, a permutation test is used as a non-parametric statistical technique to detect data drift, which entails detecting whether or not an accuracy score of the binary classifier is better than a typical score when both datasets are in a same distribution. Permutation entails obscuring which tuples come from which of the two datasets, which will either: a) confuse the classifier and decrease the accuracy of the classifier such as when both datasets are similar, or b) will not interfere with accurate classification such as when both datasets are clearly distinct such as when one dataset was recorded before data drift and the other dataset occurs after data drift.

Techniques herein provide parallelization or increased parallelization. Each of several independent trials can be performed in parallel to substantially reduce the running time of drift detection. When the estimation of a drift detecting machine learning model’s score is done using k-fold cross-validation, each of the k folds can also be used as a further granularity of parallelism.

Other techniques herein provide further acceleration. A reduced number of permutations (i.e. trials) may be achieved using an elbow method to detect a smallest count of permutations that would approximate a distribution accurately and efficiently. Down sampling may reduce a count of samples required to correctly approximate a result for a trial.

A parametric permutation test may be used for acceleration. A permutation test may examine whether or not a given scalar statistic is at least as extreme as a quantile of a distribution of permuted version of the scalar statistics. However herein, the score of a model may be estimated by taking a mean score over multiple cross-validation folds. An alternative to comparing only this scalar mean to the distribution of means, is to use a t-test to determine whether or not the set of scores for both datasets are from a same distribution. Because a t-test assumes normality of a dataset, this provides a more powerful method at a reduced computational cost (i.e., to obtain similar results with an even smaller number of permutations). It is novel to take advantage of multiple independent trials by assuming that they are normally distributed and using a t-test to further reduce the number of permutations needed to obtain a stable result.

Unlike the permutation approach, the anomaly detector approach instead detects dataset drift and discerns if old and new samples are from the same or different distributions based on outlier scores. This entails randomly subsampling two datasets respectively. Only when the two datasets are similar such that one dataset has not drifted away from the other dataset, then the outlier scores of the two datasets are similar. When the two outlier scores diverge, data drift has occurred, which is a novel detection approach.

A probabilistic two-arm bandit algorithm provides novel acceleration and increased reliability to the above anomaly detector approach. In cases of clear data drift, increased efficiency is realized by dynamically reducing the number of iterations (i.e. independent trials). In cases of subtle data drift, increased reliability is realized by dynamically increasing the number of iterations to obtain a stable result.

In a permutation embodiment, to each tuple in old tuples, a first label is assigned that indicates the old tuples. To each tuple in recent tuples, a second label is assigned that indicates the recent tuples. Combined tuples are generated by combining the old tuples and recent tuples. Permuted tuples are generated by randomly permuting the labels of the combined tuples. A computer measures a first fitness score of a binary classifier that infers, respectively for each tuple in the combined tuples, the first label that indicates the old tuples or the second label that indicates the recent tuples. Also measured is a second fitness score of the binary classifier that infers, respectively for each tuple in the permuted tuples, the first label or the second label. A target machine learning model may be retrained with recent data when a comparison of the first fitness score to the second fitness score indicates data drift.

In an anomaly detector embodiment, a first small subset and a large subset are randomly sampled from old tuples. A second small subset is randomly sampled from recent tuples. The first small subset and large subset are combined to generate first combined tuples. The second small subset and large subset are combined to generate second combined tuples. A computer measures a first outlier score from an anomaly detector that infers, respectively for each tuple in the first combined tuples, an outlier score that indicates whether the tuple is anomalous. Also measured is a second outlier score from the anomaly detector that infers, respectively for each tuple in the second combined tuples an outlier score that indicates whether the tuple is anomalous. A target machine learning model may be retrained with recent data when a comparison of the first outlier score to the second outlier score indicates data drift.

In a two-arm bandit embodiment, each iteration uses, as particular tuples, either old tuples or recent tuples depending on respective probabilities. A small subset is randomly sampled from the particular tuples. A large subset is randomly sampled from the old tuples. Both subsets are combined to generate combined tuples. A computer measures an average outlier score of the combined tuples. The probability of the particular tuples is adjusted based on the average outlier score of the combined tuples. A target machine learning model may be retrained with recent data when the probability of the recent tuples indicates data drift.

### 1.0 Example Computer

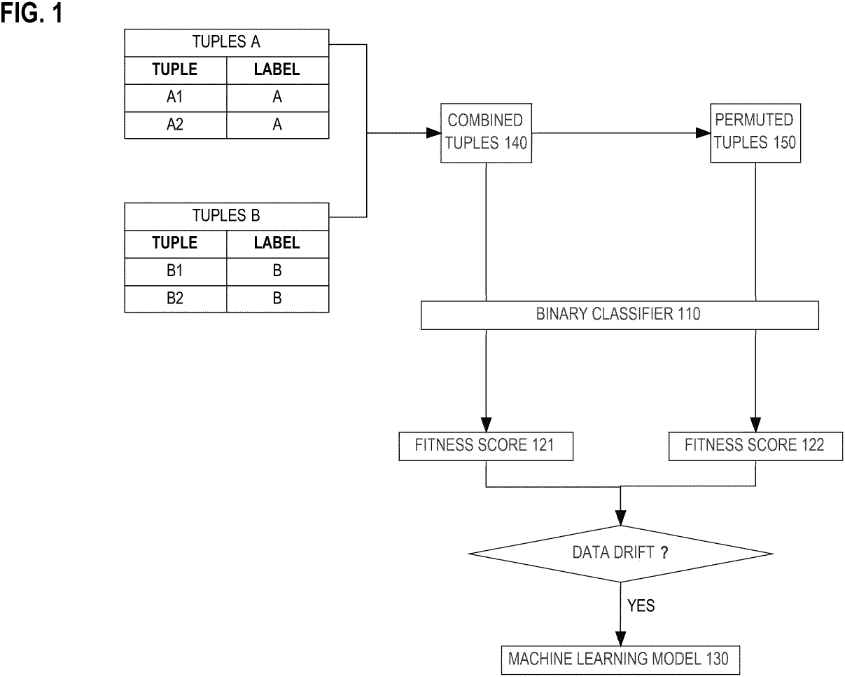

FIG. 1 is a block diagram that depicts an embodiment of an example computer 100 that applies machine learning (ML) techniques to compare tuples A-B of different respective ages to detect data drift without a predefined threshold. Computer 100 may be one or more of a rack server such as a blade, a personal computer, a mainframe, a virtual computer, a smartphone, or other computing device.

### 1.1 Datasets, Tuples, and Labels

In an embodiment, computer 100 stores and operates or processes tuples A-B, binary classifier 110, and ML model 130. Tuples A-B may be telemetry samples, (e.g. database) records, operational (e.g. console) log entries, (e.g. structured query language, SQL) commands, JavaScript object notation (JSON) or extensible markup language (XML) documents, (e.g. internet protocol, IP) network packets, or other data field aggregations such as an array or set of name-value pairs. In an embodiment, tuples A-B were delivered to computer 100 in a same data stream, but tuples B are recent (e.g. live) and selected from a small population of a few (e.g. tens or thousands) tuples, and tuples A are old (e.g. archived) and selected from a large population of many (e.g. millions) tuples. Even though tuples A-B come from separate populations of different sizes, tuples A-B have a same count of tuples.

In an embodiment, computer 100 has (e.g. volatile and/or random access) memory that stores binary classifier 110 and machine learning model 130 and caches, buffers, or stores some or all tuples of tuples A-B. Tuples may be demonstratively or actually assigned a label that indicates which of tuples A-B contains each tuple. For example, label A indicates that tuples A contains individual tuples A1-A2, and label B indicates that tuples B contains individual tuples B1-B2. Thus, when tuples A-B are combined to be combined tuples 140 that contains tuples A1-A2 and B1-B2, the label of any tuple in combined tuples 140 may later be inspected to detect which of tuples A-B provided the tuple.

### 1.2 Binary Classifier and Target ML Model

In an embodiment, labels A-B may be used for supervised learning for binary classifier 110 that infers one of labels A-B for any tuple in tuples A-B. Binary classifier 110 and ML model 130 are ML models that can inference based on tuples A-B. Binary classifier 110 and ML model 130 may have a same or different architecture and have a same or different function.

For example, binary classifier 110 may be a random forest for classification and ML model 130 may be a neural network for regression. Likewise, binary classifier 110 and ML model 130 may both be classifiers for respective label sets of a same or different size and may both be neural networks of a same or different kind. For example, binary classifier 110 and ML model 130 may have different values for a same set of hyperparameters or may have different hyperparameters.

The purpose of ML model 130 is to provide application specific analysis such as forecasting or anomaly detection. For example, ML model 130 may process a stream or batch of tuples to provide a respective inference of each tuple such as predicting a future numeric cost that is implicated by the tuple or detecting that the tuple represents a network packet that is or is not anomalous. The purpose of binary classifier 110 is to detect whether or not tuples A-B have a same or different distribution of data values in their tuples. If the distributions significantly differ, then data drift has occurred and is detected as explained later herein.

In various exemplary embodiments, ML model 130 is at least one of the following:
an anomaly detector (or a binary classifier) that can detect whether or not a tuple is anomalous,
an opaque (i.e. black box) ML model whose internals are inaccessible or confusing,
an unsupervised learning model that does not need training labels, and/or
an ML model based on a same ML algorithm as binary classifier 110, although both models may have different hyperparameters values.

In an embodiment not shown, binary classifier 110 and ML model 130 reside in separate computers. For example, ML model 130 may be embedded in a network switch for packet sniffing to detect a suspicious packet, and binary classifier 110 may reside in a server computer in a same or different datacenter. For example, the network switch may be somewhat stateless and contain only some or all of recent tuples B but none of old tuples A. Whereas binary classifier 110 may access archived tuples A and receive, from the network switch, recent tuples B as a batch or by accumulation of individual tuples B1-B2 over some period. In an embodiment, tuples B may eventually be archived to supplement or replace some or all of tuples A.

### 1.3 Data Drift

Values in a data stream of tuples may naturally fluctuate according to patterns such as randomness, periodicity, and trend. MLmodel 130 was trained with tuples that provided a data values distribution that initially resembled the data values distribution of the data stream. However over time, the data values distribution of the data stream may so significantly diverge from the training values distribution to cause ML model 130 to lose accuracy and become unreliable. A significant values distribution shift is known as data drift, dataset drift, or concept drift.

A best practice is to retrain MLmodel 130 with recent tuples (e.g. including tuples B) due to detected or expected data drift to effectively recalibrate ML model 130 for a new data distribution regime. Other techniques may periodically, frequently, and prophylactically retrain MLmodel 130 without even attempting to detect data drift. However, frequent retraining is expensive. For example, retraining may take hours or days. Thus, there is a natural tension between frequent retraining to maximize accuracy and infrequent retraining to minimize cost.

However, knowing how much data drift is significant enough to need retraining may be a technical challenge for several reasons. For example, establishing a predefined threshold amount of data drift may depend on many factors, including multidimensional factors, such as a feature set, observed values ranges, possible values ranges, model architecture, hyperparameters values, and expected dynamic patterns such as seasonality, noise, and trends.

Thus, a drift threshold should be different for different subject matter domains and application specifics, and the drift threshold may itself need adjustment over time. For example, a bank account balance may be range bound in February but not in December for holiday shopping. Thus, February and December may need different drift thresholds, which may invalidate a predefined fixed drift threshold.

### 1.4 Tuple Features

Tuples A-B share a same set of features, and a drift threshold that works for one feature might not work for another feature in the feature set. Other techniques may entail predefining a separate drift threshold for each feature according to the natural units or statistical variance of the feature. Techniques herein use a single drift threshold that is entirely independent of features and, in many cases, never or seldom needs adjusting.

Other techniques may be somewhat or entirely unable to detect data drift that is based on a combination of multiple features such as correlated and/or uncorrelated features. Techniques herein are agnostic as to which feature(s) cause data drift. Especially problematic for other approaches may be data drift caused by a group of multiple drifting tuples that disagree on which feature is drifting such that drift can only be detected with the group as a whole because drift for any one feature is somewhat insignificant in isolation. Techniques herein are robust when multiple isolated insignificant patterns of drifting have a diffuse but significant aggregate effect.

Various features may have various respective datatypes and/or ranges that may confuse other drift detection approaches to cause reliability degradation such as inaccuracy, low confidence, and/or instability. ML model 130 may accept as input (e.g. in a feature vector having multiple features, where the feature vector encodes one tuple) the following kinds of features that may be troublesome for other approaches but not troublesome for approaches herein:
a categorical feature that has mutually exclusive discrete choices such as colors or tea flavors,
an integer feature having fewer than a thousand possible values such as a day of week or day of year, and
an integer feature having a range that includes gap(s) such as prime numbers.

Thus, approaches herein may accept and tolerate features that other approaches may preferably or necessarily exclude such as during feature engineering.

### 1.5 Data Drift Detection

Another technical problem is that, although the accuracy of ML model 130 is decreased by data drift, monitoring the current accuracy of ML model 130 may be very expensive. For example, accuracy measurement techniques such as involving counts of true and/or false positives and/or negatives of inferences, such as in a confusion matrix, cannot be established without labels (i.e. known correct inferences for respective tuples). Labeling tuples may entail painstaking manual labor by a slow and expensive domain expert.

Techniques herein detect data drift without using the label set (which is not labels A-B) of ML model 130 and without measuring and monitoring the accuracy of ML model 130. Indeed, ML model 130 is unnecessary to detect data drift. An embodiment may lack ML model 130 and still detect data drift.

In various embodiments, ML model 130 does not inference tuples A and/or B before at least one of: a) generation of combined tuples 140 and/or permuted tuples 150, b) binary classifier 110 inferences combined tuples 140 and/or permuted tuples 150, and/or c) techniques herein detect that data drift has or has not occurred. In various embodiments, ML model 130 is itself a classifier that uses application-specific labels (not labels A-B), and: a) tuples A and/or B lack the application-specific labels before techniques herein detect that data drift has or has not occurred, and/or b) ML model 130 does not infer application-specific labels for tuples A and/or B before techniques herein detect that data drift has or has not occurred.

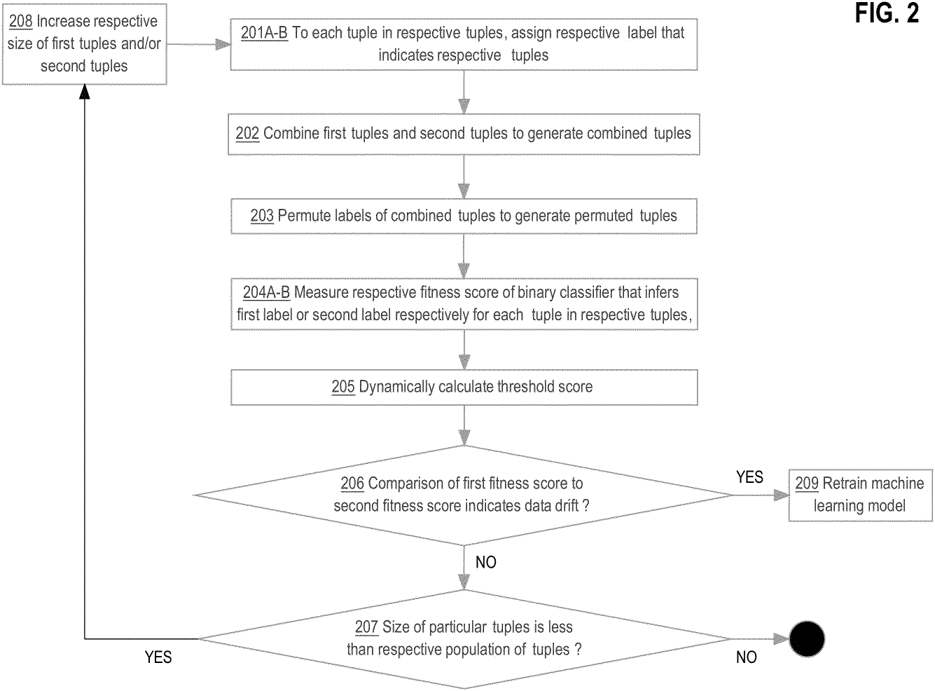

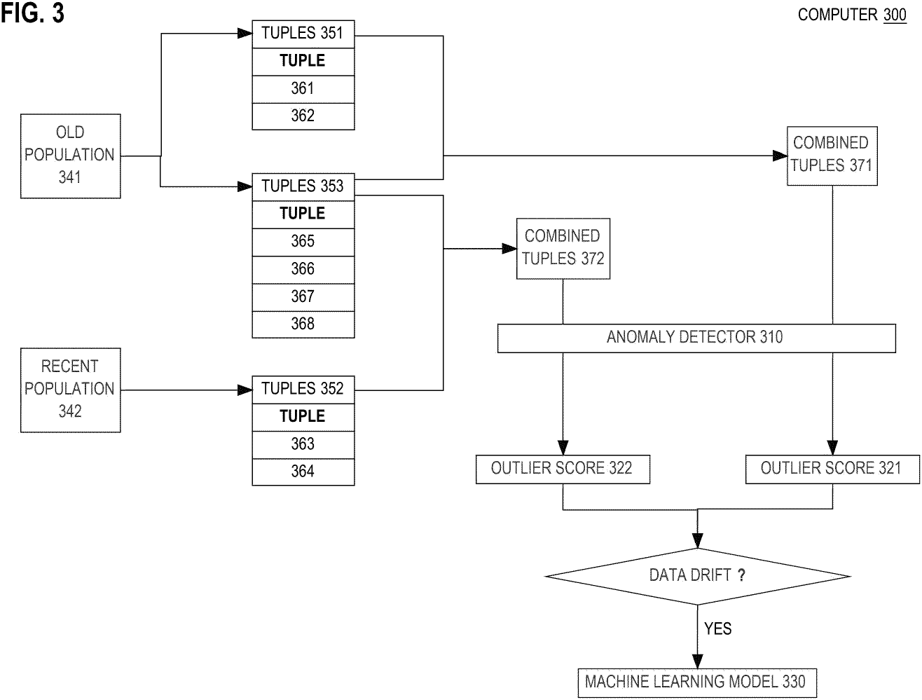

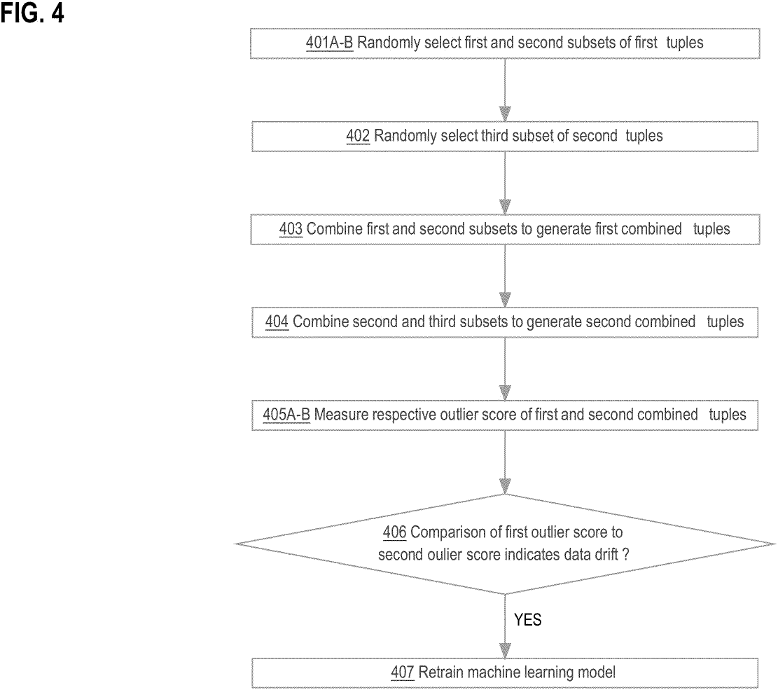

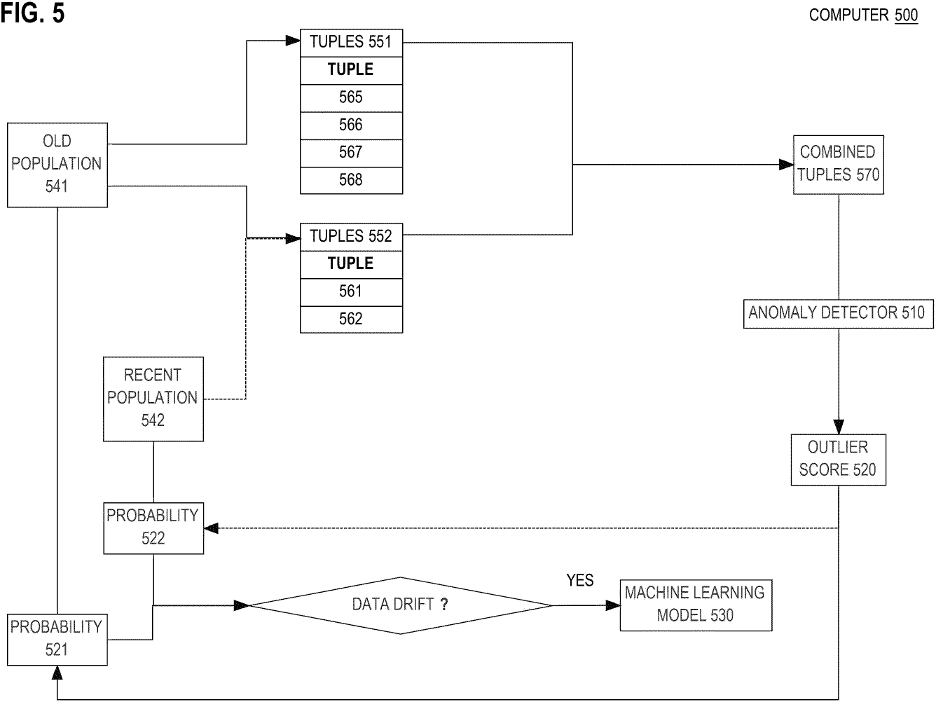

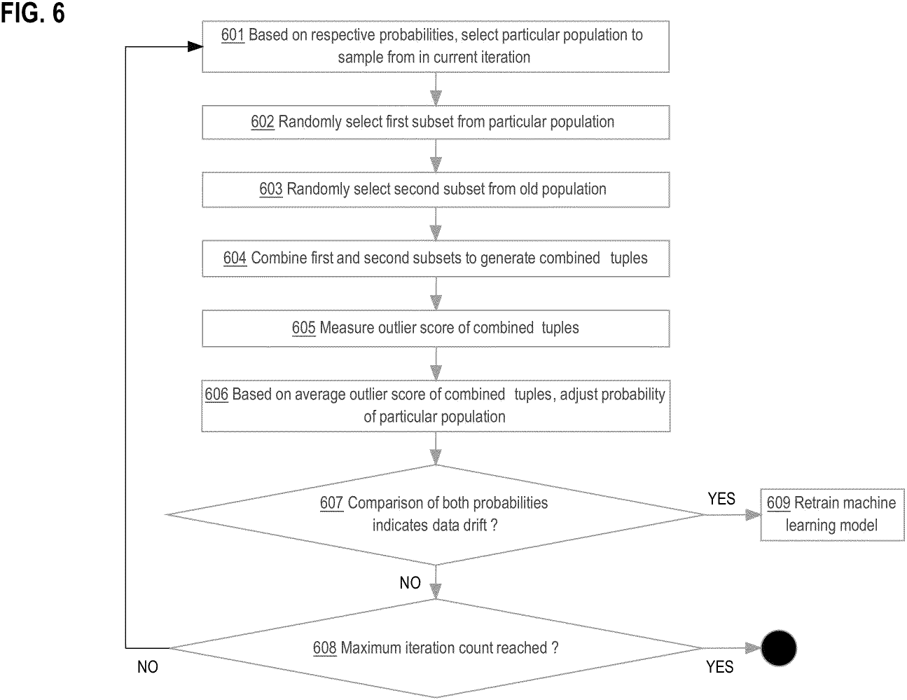

Herein are three distinct approaches to drift detection. FIGS. 1-2 show drift detection based on permutation. FIGS. 3-4 show drift detection based on outlier detection. FIGS. 5-6 show drift detection based on bandits. Although these three approaches have different architectures, all of these approaches detect data drift in respective ways that are independent of data features, do not need threshold adjustment, and do not need a target ML model (e.g. 130).

### 1.6 Permutation

Drift detection based on simulated resampling by label permutation is as follows. As explained earlier herein, tuples A may be part of a population of old tuples and tuples B may be part of a population of new tuples. Tuples A-B are filled by random sampling of those respective populations. Randomly sampled tuples A-B are combined to generate combined tuples 140. Thus, combined tuples 140 is effectively a random sampling of the respective populations from which tuples A-B were sampled.

Permuted tuples 150 may be generated by permuting combined tuples 140 as follows. Permuted tuples 150 has a same count of tuples as combined tuples 140. Mechanisms of permutation are discussed later herein.

As discussed earlier herein, the tuples A1-A2 have label A and tuples B1-B2 have label B to indicate their provenance. Those labels are permuted (e.g. shuffled) in permuted tuples 150 to obscure that provenance and simulate resampling. Thus, permuted tuples 150 contains the same tuples as combined tuples 140, but permuted tuples 150 has a distinct reassignment of labels.

Binary classifier 110 attempts to infer the original (i.e. unpermuted) label of a permuted tuple. Mechanisms and timing of training binary classifier 110 are discussed later herein. In particular, trained binary classifier 110 is operated to infer labels for a batch of tuples. Permuted tuples 150 and combined tuples 140 are two separate batches. More batches by multiple permutations and/or cross validation are discussed later herein.

An inference by binary classifier 110 entails one tuple, and the inference does or does not match the tuple’s current (e.g. permuted) label. If data drift has occurred, then tuples A have significantly different values than tuples B, which has the following consequences for binary classifier 110. With drift having occurred, binary classifier 110 is able to somewhat reliably recognize which tuples have or have not drifted. If tuples A occurred before drift and tuples B occurred after drift, then binary classifier 110 is able to somewhat reliably infer the original (i.e. unpermuted) labels in both permuted tuples 150 and combined tuples 140, which has the following implications.

### 1.7 Fitness Score

With data drift causing tuples B to significantly diverge from tuples A, binary classifier 110 is able to somewhat reliably infer the labels of combined tuples 140 because those labels are unpermuted. This reliability is reflected in fitness score 121 for combined tuples 140. In an embodiment, fitness score 121 measures the fitness of binary classifier 110. Herein a fitness score is also referred to as a validation score if the fitness score is calculated by validating (e.g. cross validation) the binary classifier.

Fitness scores and cross validation are discussed later herein. There are various kinds of fitness scores such as accuracy, area under a receiver operating characteristic curve (ROC AUC), and F1. For example, a fitness score may be based on a percentage or count of correct inferences for a batch.

Also discussed later herein is an outlier score that, while not semantically interchangeable with a fitness score, may have functionally somewhat similar uses in some contexts herein. Each of a fitness score and an outlier score may be an aggregate score that contains or is based on compound data as follows. An aggregate score may contain or be based on constituent scores that are more or less the same kind of score as the aggregate score.

For example, either or both of fitness scores 121-122 may be an aggregate score that is an average or sum of constituent scores that also are fitness scores. Aggregate scores and constituent scores are discussed later herein. A same fitness score or outlier score may, in different contexts herein, be differently treated as: a) an aggregate score that is not a scalar because it is a plurality of constituent scores, or b) an aggregate score that is a scalar because it is a mean or sum of constituent scores. Thus, whether fitness score 121 is or is not a scalar depends on the context herein.

Although both of fitness scores 121-122 may be an aggregate score having multiple constituent scores, both aggregate scores may have different respective counts of constituent scores such as due to having respective constituent score arrays of different respective dimensionality. For example due to alternation count (i.e. n in Table 1 later herein) of alternative permutation instances as explained later herein, fitness score 122 may have a constituent score array that has one more dimension than the constituent score array of fitness score 121. Also due to cross validation folds explained later herein, both of fitness scores 121-122 may have multidimensional constituent score arrays, either actually or, if after score rollup aggregation, at least conceptually as explained later herein.

### 1.8 Comparing Fitnesses

With data drift causing tuples B to significantly diverge from tuples A, binary classifier 110 somewhat reliably infers the original (i.e. unpermuted) labels of any batch, permuted or not. However because permuted tuples 150 contains permuted labels, binary classifier 110’s inferred original labels will not match the permuted labels. Thus with data drift causing tuples B to significantly diverge from tuples A, binary classifier 110 is more or less accurate for combined tuples 140 but inaccurate (i.e. seemingly guessing randomly) for permuted tuples 150 that is based on permuted labels.

In other words, when data drift separates tuples A from tuples B, binary classifier 110’s fitness for combined tuples 140 is distinct from binary classifier 110’s fitness for permuted tuples 150. Based on that observable fitness distinction between the two batches, the shown decision diamond detects, by comparing fitness scores 121-122, that data drift has occurred, which is shown as yes. In that case, any ML model(s) that depend on the data stream that provided tuples A-B is at risk of being or soon becoming inaccurate because that data stream has drifted. For example when data drift is detected as shown, then ML model 130 should be retrained with recent data to recalibrate for accommodating the data drift.

When comparing scores, the decision diamond may use a more or less universal threshold discussed later herein. Based on that threshold, the comparison does or does not indicate data drift. For example if data drift has not occurred, then values in tuples A should resemble values in tuples B.

Regardless of whether drift has or has not occurred, binary classifier 110 is inaccurate (i.e. seemingly guessing randomly) for permuted tuples 150 as explained above. However because tuples A-B are more or less indistinguishable without data drift, binary classifier 110 is more or less equally inaccurate for combined tuples 140 without data drift. In other words, without data drift, binary classifier 110’s fitness is always poor regardless of whether a batch is permuted or not. In that case, data drift is not detected and ML model 130 does not need retraining.

### 2.0 Pseudocode Based on Permutation

Computer 100 may execute lines 1-16 in the following example permutation pseudocode to perform the example permutation process of FIG. 2 discussed later herein.

1. # preprocess the input (filter out NANs etc.)
2. # and assign labels based on the source of the data
3. ds_p = preprocess_dataset(X=p, y=zeros(len(p))
4. ds_q = preprocess_dataset(X=q, y=ones(len(q))
5. X = concatenate(ds_p.X, ds_q.X, axis=0)
6. y = concatenate(ds_p.y, ds_q.y, axis=0)
7. score_dist = [ ]
8. for i in range(n):
9. # shuffling the labels simulates resampling
10. # from the combined distribution (P and Q)
11. score = cross_validate(
model, X, y, shuffle_labels=True)
12. score_dist.append(score)
13. score = cross_validate(
model, X, y, shuffle_labels=False)
14. quantile = calculate_quantile(score_dist, 1-alpha)
15. summary = 'p ≈_{α} q' if score < quantile else 'p ≉_{α} q'
16. return final_decision, score, score_dist, quantile,

The following Table 1 describes the following variables that occur in the following lines of the above example permutation pseudocode. The logic and subroutine invocations in lines 1-16 in the above example permutation pseudocode are explained later herein with the example permutation process of FIG. 2.

| Line | Variable | Meaning |
|---|---|---|
| 3 | p | Tuples A before labeling |
| 3 | ds_p | Tuples A after labeling |
| 4 | q | Tuples B before labeling |
| 4 | ds_q | Tuples B after labeling |
| 5 | X | Combined tuples 140 excluding labels |
| 6 | y | Labels for combined tuples 140 |
| 7 | score_dist | Constituent scores of fitness score 122 including one score per alternative permutation instance as explained later herein |
| 8 | n | A predefined alternation count of alternative permutation instances as explained later herein |
| 11 | shuffle_labels | A flag indicating whether or not to permute labels |
| 11 | model | Binary classifier 110 |
| 13 | score | Fitness score 121 |
| 14 | alpha | A predefined statistical significance between zero and one. E.g. 0.05 means 5%. Alpha is a universal threshold that is not data dependent. |
| 14 | quantile | A threshold score that only alpha percent of score_dist exceeds |
| 15 | summary | A Boolean indicating whether or not data drift is detected |
| 16 | final_decision | Display of the summary and conditionally retraining ML model 130 |

### 2.1 Drift Detection Process Based on Permutation

FIG. 2 is a flow diagram that depicts an example process that computer 100 may perform to apply machine learning (ML) techniques to compare tuples A-B of different respective ages to detect data drift without a predefined threshold. FIG. 2 is discussed with reference to FIG. 1 and lines 1-16 in the above example permutation pseudocode.

Steps 201-208 are a sequence that iteratively and conditionally repeats as follows. Each of steps 201A-B performs similar work on separate sets of tuples as follows. To each tuple in tuples A, step 201A assigns label A that indicates tuples A. In other words, step 201A marks the provenance of tuples A. For example, label A may indicate that tuples A were (e.g. randomly) selected from a first (e.g. large) population of (e.g. old) tuples. Step 201A may execute line 3 in the above example permutation pseudocode.

Step 201B is more or less the same as step 201A except that label B is assigned to tuples B. For example, label B may indicate that tuples B were (e.g. randomly) selected from a second (e.g. small) population of (e.g. recent) tuples. In other words, labels A-B may indicate that the tuples A-B are mutually exclusive and separate sets taken from mutually exclusive and separate populations. Step 201B may execute line 4 in the above example permutation pseudocode.

For steps 201A-B, tuple selection and labeling may be implemented in various ways. For example, selection may entail copying tuples or referencing tuples. A tuple reference may be a memory address pointer, a database table row identifier (ROWID), a database table row offset, a tuple offset into an array or file, or a byte offset into a file. A tuple reference may be a bit in a bitmap. For example, tuples A may be selected from a large population, and tuples A may be implemented as a bitmap having a bit for each tuple in the large population, with a bit being set only if a corresponding tuple is selected for inclusion in tuples A.

Labeling may be express decoration such as data field assignment or implied by set membership. For example, implicit labeling may entail mere presence of a tuple in tuples A.

Step 202 combines tuples A-B to generate combined tuples 140. Combining may entail copying tuples or referencing tuples as explained above. Although combined tuples 140 comingles tuples A1-A2 and B1-B2 from different populations, the labels preserve the respective provenance of each tuple in combined tuples 140. Step 202 may execute lines 5-6 in the above example permutation pseudocode.

Step 203 permutes labels of combined tuples 140 to generate permuted tuples 150 as follows. Label permutation is random. For example, combined tuples 140 may have a sequential ordering, in which case the labels of combined tuples 140 may also have an original ordering. Step 203 may be part of executing line 11 in the above example permutation pseudocode.

Random permutation may entail generating a second ordering of labels that is a randomization of the original ordering of labels. In other words, tuples remain in place such that the ordering of tuples in combined tuples 140 and permuted tuples 150 is the same, but the two orderings of labels differ.

Permutation may entail randomly pairing tuples such that each tuple occurs in one or two pairs depending on the embodiment. If each tuple occurs in two pairs, then the tuple’s original label is read in one pair and permuted in the other pair. Thus in a first embodiment in which each tuple occurs in two pairs: a) in a first pair, a first tuple may provide its original label to be the permuted label of a second tuple, and b) in a second pair, a third tuple may provide its original label to be the permuted label of the first tuple. In a second embodiment where each tuple occurs in only one pair, both tuples in the pair swap labels.

In an embodiment, combined tuples 140 and permuted tuples 150 each has a respective bitmap having a bit for each tuple in tuples 140 or 150. Each bit is clear or set based on whether a label for the tuple in that particular set is respectively A or B. In any case, frequencies of labels A-B are preserved despite permutation. Permuted tuples 150 may be populated by copy or by reference.

In various embodiments, permutation step 203 entails at least one of:
assigning the label of a tuple of combined tuples 140 to a different tuple of permuted tuples 150,
in permuted tuples 150, preserving respective frequencies of labels A-B that occur in combined tuples 140,
reassigning the label of a tuple of permuted tuples 150 to a randomly selected one of labels A-B, and
reassigning the label of a randomly selected tuple of permuted tuples 150 to a different label.

In an embodiment, permutation step 203 is repeated an alternation count of times for one occurrence of combination step 202. Thus, steps 202-203 may generate one instance of combined tuples 140 and many alternative instances of permuted tuples 150, each with its own alternative reordering of labels. The alternation count (i.e. n in above Table 1) may be experimentally predetermined by detecting a knee of a curve.

For example, an experiment may entail many trials. Each trial may have: a) a distinct alternation count (i.e. count of permutation instances) as explained earlier herein, and b) a fitness score. The curve may be demonstratively plotted with alternation count as the independent axis and fitness score as the dependent axis. With small alternation counts, the fitness scores are low (i.e. poor) and progressively increasing the alternation count causes a diminishing increase in fitness scores that eventually transitions from significantly increasing fitness to insignificantly increasing fitness. The point of that transition is the knee of the curve, which may be visually (i.e. manually) or mathematically detected.

Each of steps 204A-B performs similar work on separate sets of tuples as follows. In steps 204A-B, binary classifier 110 is individually applied to each of multiple tuples to generate respective inferences, which requires that binary classifier 110 was trained either as an immediate preface to steps 204A-B or was trained long ago. For example after step 202 that generates combined tuples 140, and before inference steps 204A-B, binary classifier 110 may be trained with combined tuples 140 as a training corpus. Training may instead occur within steps 204A-B if cross validation is used as explained below. In any case, training of binary classifier 110 is supervised based on labels A-B.

Steps 204A-B measure fitness scores 121-122 of binary classifier 110 that infers labels A-B respectively for each tuple in a respective set of tuples. Step 204A measures fitness score 121 for combined tuples 140, and step 204B measures fitness score 122 for permuted tuples 150. Steps 204A-B may be validation steps, and fitness scores 121-122 may be validation scores. Step 204A may execute line 13 in the above example permutation pseudocode. Step 204B may execute line 11 in the above example permutation pseudocode.

In a low-confidence embodiment, steps 204A-B make a single pass over their respective tuple sets. In other words, each tuple in each set is inferenced only once. Confidence in score measurement is increased by reusing tuples multiple times for training and validation such as by performing cross validation in steps 204A-B. With cross validation, a set of tuples may be horizontally partitioned into multiple subsets known as folds. With horizontal scaling, many or all folds are concurrently processed for acceleration.

K-fold cross validation in steps 204A-B includes repeated training and repeated validation of binary classifier 110. Step 204A may use combined tuples 140 as a training corpus. Step 204B may use permuted tuples 150 as a training corpus. Either training corpus may or may not exclude a minority of tuples for inclusion in a holdout validation fold.

Monte Carlo cross validation may be used that randomly samples tuples for inclusion in a training fold or a validation fold. As explained above, permutation step 203 preserves the frequency of labels A-B such that when tuples A-B have equal counts of tuples, then permuted tuples 150 has equal counts of permuted labels A-B. Stratified Monte Carlo cross validation may be used to ensure each fold has equal counts of labels.

Step 205 dynamically calculates a threshold score that is shown as ‘quantile’ in above Table 1. Unlike other approaches, the threshold score is not predetermined and does not depend on: a) specifics of binary classifier 110, b) existence of ML model 130, nor c) specifics of tuples A-B. Instead, the threshold score depends solely on score_dist and alpha in above Table 1, and score_dist cannot be predetermined.

As explained earlier herein, permutation step 203 may have an alternation count (i.e. n in above Table 1). Score_dist is a set of fitness scores and has size n that, in an embodiment, is 101 or another odd integer. Each alternative instance of permuted tuples 150 provides one fitness score in score_dist, and score_dist may be sorted to reveal some highest fitness scores.

Step 205 may execute line 14 of the above example permutation pseudocode to calculate the threshold score that is a scalar. As explained in Table 1, ‘quantile’ is not itself a quantile but instead is a lower boundary of a highest quantile of score_dist. That means a threshold score that fitness score 121, as a scalar, should exceed to fall within a highest quantile (per alpha in above Table 1) of score_dist. For example when alpha is 0.1, drift detection step 206 may detect whether or not fitness score 121, as a scalar average of constituent scores, falls within or exceeds the highest decile of score_dist. Step 206 operates as follows.

Steps 206-207 are shown as yes/no decision diamonds. The combination of steps 206-207 may implement the decision diamond of FIG. 1. Step 206 detects whether or not a comparison of fitness scores 121-122 indicates data drift. In other words, step 206 detects: a) whether or not permuted tuples 150 significantly differs from combined tuples 140 and thus b) whether or not tuples B have significantly diverged from tuples A.

In an embodiment, comparison by step 206 is based on a highest quantile as defined by step 205. In an embodiment, step 205 is not implemented, and step 206 instead applies a statistical t-test to compare the distributions of the respective constituent scores of fitness scores 121-122.

If step 206 detects data drift, then step 209 occurs as explained later herein. Otherwise, step 207 occurs that detects whether or not increasing a size (i.e. count of tuples) of combined tuples 140 and/or permuted tuples 150 would exceed the size of their respective populations from which they are sampled. For example, populations 341-342 are discussed later herein for FIG. 3.

Steps 207-208 facilitate iteration of the process of FIG. 2. In an embodiment, the size of combined tuples 140 and/or permuted tuples 150 are iteratively increased, which provides acceleration by dynamically/adaptively discovering an optimal size. As explained earlier herein, accessing a tuple population (e.g. archive) on disk may entail slow input/output (I/O). Thus, there is a design tension between minimizing the sample size for speed and maximizing the sample size for accuracy/confidence.

Step 207 detects whether or not increasing a sample size would exceed the size of the underlying population. In other words, step 207 detects whether or not the underlying population would be exhausted. If the sample size could be increased without exceeding the size of the underlying population, then step 208 occurs as explained below. Otherwise, iteration ceases without detecting data drift as shown by the black circle.

Step 208 increases the size of tuples A and/or B. Step 208 performs resampling from scratch, which means that the previous smaller sampling of the previous iteration is forgotten. That is, a next sampling in the next iteration is not merely a superset of a previous sampling. Such sampling is: a) random, b) from an underlying population, and c) not simulated by permutation. The next iteration with a larger sampling proceeds to step 201A and the process of at least steps 201-206 is repeated.

A maximum count of iterations is decreased if step 208 exponentially increases the sample size. If step 208 super-exponentially increases the size, then the maximum count of iterations is or nearly is constant and independent of the size of the underlying population, in which case scalability is ensured. In various embodiments, the sample initially (i.e. in a first iteration) is at most 10% or at most 1% of an underlying population of tuples.

In some iteration, step 206 may, as explained earlier herein, detect data drift and cause step 209 that retrains ML model 130 with recent tuples such as tuples B or with the population of recent tuples that underlies tuples B. Step 209 also ceases iteration. Thus, retraining is based on drift detection by step 206 in the last iteration.

### 3.0 Example Anomaly Detection

FIG. 3 is a block diagram that depicts an embodiment of an example computer 300 that applies machine learning (ML) techniques to compare tuples 351-352 of different respective ages to detect data drift. Although computer 300 is not an implementation of computer 100, computers 100 and 300 may be implemented with reusable logic. Another embodiment may combine aspects of computers 100 and 300 according to any design choice herein.

For example, computer 100 may be discussed based on cross validation, and computer 300 may instead be discussed without cross validation, but computer 300 may also be implemented with cross validation. Likewise, computer 100 may be discussed based on iteration, and computer 300 may instead be discussed without iteration, but computer 300 may also be implemented with iteration.

Computers 100 and 300 detect divergence of two sets of tuples in different respective ways because computer 300 lacks labels A-B and permutation. Tuples 351 includes individual tuples 361-362 that are sampled from old population 341. Tuples 352 includes individual tuples 363-364 that are sampled from recent population 342. Tuples 353 includes individual tuples 365-368 that are sampled from old population 341. For computer 300, sampling is not simulated by permutation. Mechanisms of sampling are discussed earlier herein.

Tuples 353 is: a) combined with tuples 351 to generate combined tuples 371 and b) combined with tuples 352 to generate combined tuples 372. Mechanisms of combining sets of tuples are discussed earlier herein. As shared by combined tuples 371-372, tuples 353 is based on old population 341 but not recent population 342. Tuples 351-352 may have a same count of tuples, and tuples 353 may have (e.g. a whole multiple) more tuples.

Unlike binary classifier 110 that infers labels A-B, anomaly detector 310 instead infers an outlier score. An outlier score has semantics that differ from a fitness score. A higher fitness score indicates that binary classifier 110 correctly inferred label(s) of tuple(s).

A higher outlier score indicates nothing about anomaly detector 310 and instead indicates a likelihood that tuple(s) are outlier(s) (i.e. anomalous). By definition, an anomalous tuple significantly differs from the training corpus (e.g. old population 341) of anomaly detector 310. Thus, outlier score 322 for combined tuples 372 might be higher than outlier score 321 for combined tuples 371.

In various embodiments, anomaly detector 310 is a special ML model such as Principal Component Analysis (PCA), Minimum Covariance Determinant, One-Class Support Vector Machines (SVM), Local Outlier Factor, Clustering-Based Local Outlier Factor, Histogram-based Outlier Score, k Nearest Neighbors (KNN), Subspace Outlier Detection, Angle-Based Outlier Detection, Isolation Forest, Feature Bagging, AutoEncoder (AE), or Variational AutoEncoder (VAE).

The shown decision diamond compares outlier scores 321-322 to detect whether or not data drift occurred, in which case tuples 352 significantly diverged from tuples 351. For example, outlier scores 321-322 may each contain or be derived from many outlier scores, known herein as constituent scores, of many folds or of many individual tuples. For example, outlier score 321 may be a scalar that aggregates (e.g. sums or averages) many constituent scores as discussed earlier herein. A highest quantile of the many constituent scores of outlier score 322 may provide a drift threshold into which scalar outlier score 321 must fall into or exceed to indicate data drift, in which case ML model 330 should be retrained.

In an embodiment, anomaly detector 310 infers an outlier score that indicates a probability (e.g. 0.0-1.0 or a percentage) that a tuple is anomalous. In an embodiment, anomaly detector 310 instead is a classifier that infers a binary label that: a) is not labels A-B of FIG. 1 and b) indicates whether or not a tuple is anomalous, in which case outlier scores 321-322 may be based on counts or percentages of tuples that are detected as anomalous. For example: a) labels A-B may be repurposed to respectively indicate non-anomalous and anomalous (which does not mean that tuples 351-353 respectively contain only anomalous or only non-anomalous tuples), and b) binary classifier 110 may be retrained to be anomaly detector 310 as discussed later herein, possibly after being reconfigured with different hyperparameters values.

### 4.0 Pseudocode Based on Outliers

Computer 300 may execute lines 1-25 in the following example outliers pseudocode to perform the example outliers process of FIG. 4 discussed later herein.

1. # preprocess the input (filter out NANs etc.)
2. ds_p_original = preprocess_dataset(X=p.X, y=p.y)
3. ds_q_original = preprocess_dataset(X=q.X, y=q.y)
4. results = [ ]
5. for x in range(n):
6. # sample from the sets
7. ds_p = resample(ds_p_origianl, n_p)
8. ds_q = resample(ds_q_original, n_q)
9. ds_r = resample(ds_p_original, n_r)
10. # create the combined dataset (p and r), and save
11. # the indices of the instances corresponding to
12. # p in the new dataset
13. Cp, indices p = concatenate(ds_p, ds_r, axis=0)
14. # create the joint dataset (q and r)
15. Cq, indices q = concatenate(ds_q, ds_r, axis=0)
16. # calculate the average outlier score of the
17. # elements of p and q, respectively.
18. Op = avg(predict_outlier _score(Cp)[indices-p])
19. Oq = avg(predict_outlier _score(Cq)[indices-q])
20. results.append(Oq - Op)
21. if sum(results) > n * ε:
22. final_decision = 'p ≉_{α} q'
23. else:
24. final_decision= 'p ≈_{α} q'
25. return final_decision, results

The following Table 2 describes the following variables that occur in the following lines of the above example outliers pseudocode. The logic and subroutine invocations in lines 1-25 in the above example outliers pseudocode are explained later herein with the example outliers process of FIG. 4.

| Line | Variable | Meaning |
|---|---|---|
| 2 | ds_p_original | Old population 341 |
| 3 | ds_q_original | Recent population 342 |
| 5 | n | A predefined count of trials as explained later herein |
| 7 | ds_p | Tuples 351 |
| 8 | ds_q | Tuples 352 |
| 9 | ds_r | Tuples 353 |
| 13 | Cp | Combined tuples 371 |
| 15 | Cq | Combined tuples 372 |
| 18 | Op | Aggregate outlier score 321 as a scalar |
| 19 | Oq | Aggregate outlier score 322 as a scalar |
| 20 | results | Set of differences between outlier scores 322 and 321 including one difference per trial as explained later herein |
| 21 | epsilon | A predefined significant difference threshold |
| 22 | final_decision | Flag indicating whether or not data drift occurred |

### 4.1 Drift Detection Process Based on Outliers

FIG. 4 is a flow diagram that depicts an example process that computer 300 may perform to apply machine learning (ML) techniques to compare tuple populations 341-342 of different respective ages to detect data drift. FIG. 4 is discussed with reference to FIG. 3 and lines 1-25 in the above example outliers pseudocode.

Unlike computer 100, computer 300 lacks labels A-B and permutation. Unlike binary classifier 110 that is supervised trained, anomaly detector 310 may be supervised or unsupervised trained.

Although the process of FIG. 4 is presented as possibly less complex than that of FIG. 2, aspects of FIG. 2 such as iteration and/or adaptive sampling may be incorporated into the process of FIG. 4. For example, n in above Table 2 is a count of trials where each trial may separately (e.g. iteratively or concurrently) execute the process of FIG. 4. FIG. 4 is demonstratively streamlined to illustrate that any of the approaches earlier or later herein may optionally be implemented with a linear control flow.

Steps 401A-B respectively randomly select tuples 351 and 353 from old (e.g. archived) population 341. A count of tuples 353 may be larger (e.g. by some multiple) than a count of tuples 351. For example, steps 401A-B may respectively execute lines 7 and 9 of the above example outliers pseudocode.

From recent population 342, step 402 randomly selects tuples 352 that may have a same count as tuples 351. Mechanisms of random sampling are discussed earlier herein. For example, step 402 may execute line 8 of the above example outliers pseudocode.

Step 403 combines tuples 351 and 353 to generate combined tuples 371. For example, step 403 may execute line 13 of the above example outliers pseudocode. Step 404 combines tuples 352-353 to generate combined tuples 372 that may have a same count as tuples 371. For example, step 404 may execute line 15 of the above example outliers pseudocode. Mechanisms of combining tuples are discussed earlier herein.

Steps 405A-B measure respective outlier scores 321-322 of combined tuples 371-372. Outlier scores 321-322 may be aggregate scores based on constituent scores that are inferred by anomaly detector 310 for individual tuples. For example, steps 405A-B may respectively execute lines 18-19 of the above example outliers pseudocode.

Decision step 406 detects whether or not a comparison of outlier scores 321-322 indicates data drift. For example, step 406 may execute line 20 of the above example outliers pseudocode to measure respective subtractive differences between constituent scores of outlier scores 322 and 321. Step 406 may execute line 21 of the above example outliers pseudocode to sum the respective subtractive differences to calculate an aggregate difference that the comparison of outlier scores 321-322 may be based on.

If the aggregate difference exceeds a predefined threshold difference, then step 406 detects data drift and may cause step 407 to retrain ML model 330 with recent data such as including recent population 342. For example, step 406 may execute line 22 of the above example outliers pseudocode that indicates that data drift occurred. Otherwise, the aggregate difference does not exceed the predefined threshold difference, and step 406 detects an absence of data drift, which does not require retraining ML model 330. For example, step 406 may execute line 24 of the above example outliers pseudocode that indicates that data drift did not occur.

### 5.0 Example Two-Arm Bandit

FIG. 5 is a block diagram that depicts an embodiment of an example computer 500 that applies machine learning (ML) techniques to compare old populations 541-542 of tuples of different respective ages to detect data drift. Although computer 500 is not an implementation of computer 100 or 300, computers 100, 300, and 500 may be implemented with reusable logic. Another embodiment may combine aspects of computers 100, 300, and 500 according to any design choice herein. For example, computer 100 may be discussed based on cross validation, and computer 500 may instead be discussed without cross validation, but computer 500 may also be implemented with cross validation.

Computers 300 and 500 detect divergence of two sets of tuples in different respective ways because computer 500 does not compare two aggregate outlier scores to detect data drift. Instead, computer 500 uses two probabilities 521-522 to temporally and probabilistically alternate between tuple populations 541-542 that entails a two-arm bandit approach that iteratively tunes probabilities 521-522 as discussed below.

Tuples 551 includes individual tuples 565-568 that are sampled from old population 541. A count of tuples 552 may be less than a count of tuples 551. Tuples 552 is sampled from either of populations 541-542 depending on probabilities 521-522. For example in a current iteration, tuples 552 is sampled from old population 541 as shown by the solid arrow that connects old population 541 to tuples 552. The arrow that connects recent population 542 to tuples 552 is shown as dashed to indicate that recent population 542 could have been used in the current iteration but is not.

Which of populations 541-542 is used in an iteration to provide tuples for tuples 552 depends on probabilities 521-522 that may fluctuate between zero and one or zero and a hundred percent. In an embodiment, probabilities 521-522 are initially 0.5. In various embodiments, probabilities 521-522 are or are not complementary (i.e. always sum to 100%). For example in an embodiment, probabilities 521-522 sum to more or less than 100%.

In an embodiment having complementary probabilities, one of probabilities 521-522 may be explicit and the other implied. For example in a complementary embodiment: a) probability 522 may be implied, b) probability 521 is a likelihood in an iteration that tuples 552 is sampled from old population 541, and c) if the old population 541 is not used for tuples 552 in the iteration, then recent population 542 is used instead. For example, if a random number from zero to one does not exceed probability 521, then old population 541 is used for tuples 552. Otherwise, the random number exceeds probability 521, and recent population 542 is instead used for tuples 552.

In an embodiment not having complementary probabilities, a separate random number is compared to respective probabilities 521-522. If only one probability is not exceeded by its respective random number, then the corresponding tuple population is used for tuples 552 in that iteration. Otherwise, another two random numbers are used until only one probability is not exceeded by its respective random number. For example, if probability 521 is exceeded by a first random number but probability 522 is not exceeded by a second random number, then tuples 552 is sampled from recent population 542.

Each iteration may have its own random number(s) and thus alternation between using populations 541-542 for tuples 552 may randomly occur. The random number is stateless and, in a current iteration, does not depend on its value in a previous iteration. However, probabilities 521-522 are stateful and fluctuate in each iteration. Although the fluctuations are not monotonic, they trend (i.e. evolve) toward equilibrium. Equilibrium does not mean that probabilities 521-522 have a same value.

In each iteration, tuples 551-552 are combined to generate combined tuples 570 that anomaly detector 510 infers respective constituent outlier scores for. The constituent scores are integrated as discussed earlier herein to generate scalar outlier score 520. Each iteration has its own tuples 552 and 570 and outlier score 520. In an embodiment, each iteration has its own tuples 551.

In each iteration, outlier score 520 as a scalar is used as a bandit reward to adjust whichever of probabilities 521-522 was used for tuples 552. For example because tuples 522 is sampled from old population 541 based on probability 521 in the current iteration, then outlier score 520 is used to adjust probability 521 in the current iteration as shown by the solid arrow that connects outlier score 520 to probability 521. Otherwise, outlier score 520 would be used to adjust probability 522 as shown by the dashed arrow that connects outlier score 520 to probability 522.

If outlier score 520 exceeds a reward threshold, then probability score 521 is increased in an embodiment. Otherwise, probability score 521 is decreased. In an embodiment, probability score 521 is increased or decreased proportional to outlier score 520. In an embodiment, the magnitude of adjustment of probability score 521 is less (e.g. a fraction of) than outlier score 520. For example, an outlier score of 0.8 may cause probability score 521 to increase by 0.1.

In an embodiment having complementary probabilities, probabilities 521-522 co-evolve in opposite directions. For example, an increase of probability 521 causes a decrease of a same magnitude for probability 522.

In an embodiment not having complementary probabilities, probability 521 is unchanged when probability 522 is adjusted, and vice versa. Thus, probabilities 521-522 independently evolve.

At the end of each iteration, probabilities 521-522 are compared to detect whether or not data drift occurred. If probability 522 exceeds probability 521 by at least a threshold difference, then recent population 542 has diverged from old population 541 and data drift is detected, in which case ML model 530 should be retrained. Otherwise, if a maximum count of iterations occurred, then data drift has not occurred and retraining ML model 530 is unneeded. In an embodiment that lacks a threshold difference, there is a minimum count of iterations after which there is an implied threshold difference of zero. In other words, data drift is detected if probability 522 exceeds probability 521 by even a tiny amount. An embodiment may have both a difference threshold and a minimum iterations count.

As explained above, a bandit algorithm is based on using outlier score 520 as or as a basis for a bandit reward, and using populations 541-542 as two bandit arms that have respective fluctuating probabilities 521-522. Various embodiments may be based on a special bandit algorithm such as Explore then Commit, Upper Confidence Bound, Asymptotically Optimal Upper Confidence Bound, and Exponential-Weight Algorithm for Exploration and Exploitation.

### 6.0 Pseudocode Based on Bandit

Computer 500 may execute lines 1-22 in the following example bandit pseudocode to perform the example bandit process of FIG. 6 discussed later herein.

1. # preprocess the input (filter out NANs etc.)
2. dsp original = preprocess dataset(X=p.X, y=p.y)
3. ds q original = preprocess dataset(X=q.X, y=q.y)
4. while bandit.not_done():
5. # Pick an arm and sample from that candidate set
6. if bandit.pick_arm(['p', 'q']) == 'p':
7. ds_c = resample(ds_p_original, n_p)
8. else:
9. ds_c = resample(ds_q_original, n_q)
10. ds_r = resample(ds_p_original, n_r)
11. # create the combined dataset(candidate and r)
12. ds_m, indices_c = concatenate(ds_c, ds_r, axis=0)
13. # calculate the probability of outliers
14. reward = predict_outlier_score(ds_m) [indices_c]
15. bandit.observe reward(avg(reward))
16. # Identify if the arm for 'q' is good enough to
17. # classify it as being from a different distribution
18. if bandit.is_best('q'):
19. final_decision = 'p ≉_{α} q'
20. else:
21. final_decision= 'p ≈_{α} q'
22. return final_decision

The following Table 3 describes the following variables that occur in the following lines of the above example bandit pseudocode. The logic and subroutine invocations in lines 1-22 in the above example bandit pseudocode are explained later herein with the example bandit process of FIG. 6.

| Line | Variable | Meaning |
|---|---|---|
| 2 | ds_p_original | Old population 541 |
| 3 | ds_q_original | Recent population 542 |
| 4 | bandit | Probabilities 521-522 |
| 7, 9 | ds_c | Tuples 552 |
| 10 | ds_r | Tuples 551 |
| 12 | ds_m | Combined tuples 570 |
| 14 | reward | Aggregate outlier score 520 as a scalar |
| 19 | final_decision | Flag indicating whether or not data drift occurred |

### 6.1 Drift Detection Process Based on Bandit

FIG. 6 is a flow diagram that depicts an example process that computer 500 may perform to apply machine learning (ML) techniques to compare tuple populations 541-542 of different respective ages to detect data drift. FIG. 6 is discussed with reference to FIG. 5 and lines 1-22 in the above example bandit pseudocode.

Based on respective probabilities 521-522, step 601 selects a particular population to sample from in a current iteration. Step 601 selects either of populations 541-542 as discussed earlier herein.

Step 602 randomly samples tuples 552 from the particular population. Step 603 randomly samples tuples 551 from old population 541. In other words, steps 602-603 may or may not sample from a same population.

Step 604 combines tuples 551-552 to generate combined tuples 570. Mechanisms of combining tuples are discussed earlier herein.

Step 605 measures aggregate outlier score 520 of combined tuples 570. As discussed earlier herein, anomaly detector 510 infers a respective constituent outlier score for each tuple.

Based on outlier score 520 as a scalar bandit reward that may be or be based on an average outlier score of combined tuples 570, step 606 adjusts whichever one of probabilities 521-522 is associated with the particular population that step 601 selected. Adjustment of probability 521 and/or 522 based on outlier score 520 is discussed earlier herein.

Step 607 compares probabilities 521-522 to detect whether or not data drift occurred. Based on that comparison, step 607 detects whether or not recent population 542 has drifted away from old population 541. Drift detection based on probabilities comparison is discussed earlier herein.

Step 607 detecting that data drift occurred causes step 609 that retrains ML model 530 such as based on populations 541 and/or 542. Step 609 ceases the process of FIG. 6 without further iterating.

If step 607 does not detect data drift, then step 608 detects whether or not a maximum count of iterations occurred. If maximum iterations occurred, then step 608 ceases the process of FIG. 6 without detecting data drift. Otherwise, maximum iterations have not occurred, and additional iteration(s) of the process of FIG. 6 occur. In that case, steps 601-607 sequentially occur again in a next iteration as shown.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

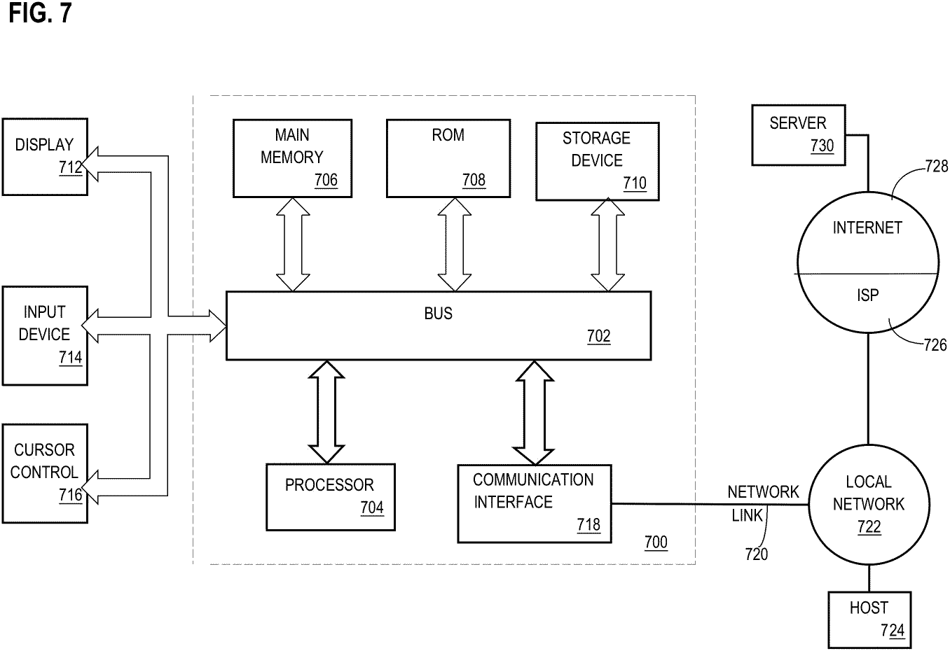

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

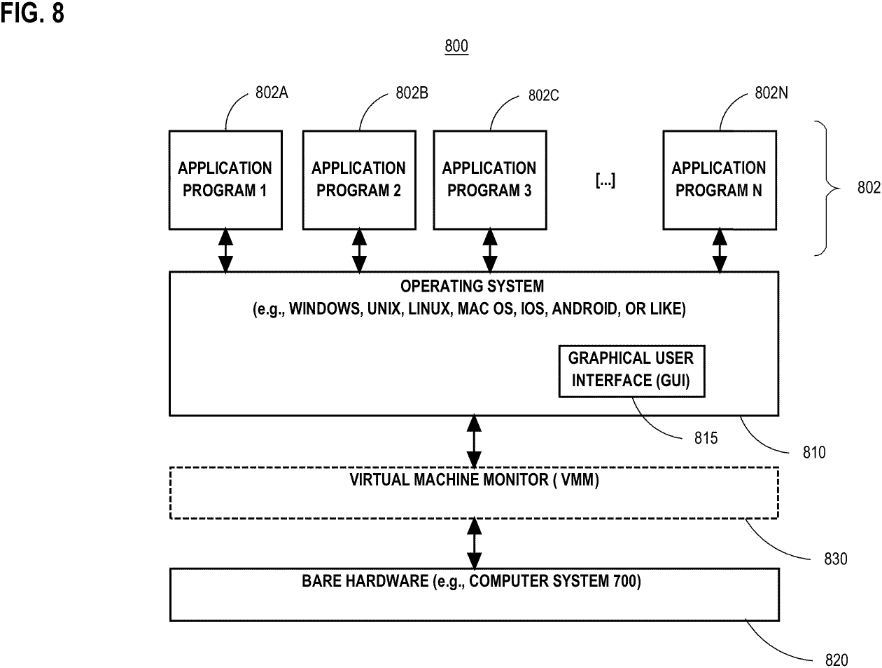

FIG. 8 is a block diagram of a basic software system 800 that may be employed for controlling the operation of computing system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C ... 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization’s own information technology department, to instead be delivered as service layers within a cloud environment, for use by consumers (either within or external to the organization, according to the cloud’s public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google’s TensorFlow for Python and C++ or Georgia Institute of Technology’s MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron’s activation value is an input to the activation neuron’s activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L-1 to a layer L. Given the number of neurons in layer L-1 and L is N[L-1] and N[L], respectively, the dimensions of matrix W is N[L-1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L-1 to L. An activation neuron represents an activation function for the layer that includes the activation function. An activation neuron in layer L corresponds to a row of weights in a matrix W for the edges between layer L and L-1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google’s TensorFlow for Python and C++, OpenNN for C++, and University of Copenhagen’s fast artificial neural network (FANN). These libraries also provide model training algorithms such as backpropagation.

### Backpropagation

An ANN’s output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge’s error delta times the activation value of the upstream neuron. When the gradient is negative, the greater the magnitude of error contributed to the network by an edge, the more the edge’s weight should be reduced, which is negative reinforcement. When the gradient is positive, then positive reinforcement entails increasing the weight of an edge whose activation reduced the error. An edge weight is adjusted according to a percentage of the edge’s gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction loss is taught in non-patent literature (NPL) “VARIATIONAL AUTOENCODER BASED ANOMALY DETECTION USING RECONSTRUCTION PROBABILITY”, Special Lecture on IE. 2015 Dec 27;2(1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
assigning:
to each tuple in a first plurality of tuples, a first label that indicates the first plurality of tuples, and
to each tuple in a second plurality of tuples, a second label that indicates the second plurality of tuples;
combining the first plurality of tuples and the second plurality of tuples into a combined plurality of tuples;
permuting the labels of the combined plurality of tuples to generate a permuted plurality of tuples;
measuring:
a first fitness score of a binary classifier that infers, respectively for each tuple in the combined plurality of tuples, the first label that indicates the first plurality of tuples or the second label that indicates the second plurality of tuples, and
a second fitness score of the binary classifier that infers, respectively for each tuple in the permuted plurality of tuples, the first label that indicates the first plurality of tuples or the second label that indicates the second plurality of tuples;
retraining a machine learning model when a comparison of the first fitness score to the second fitness score indicates data drift.

2. The method of claim 1 wherein:
the method further comprises in each iteration of a sequence of iterations:
randomly selecting the first plurality of tuples and the second plurality of tuples,
said combining the first plurality of tuples and the second plurality of tuples,
said permuting the labels of the combined plurality of tuples,
said measuring the first fitness score and the second fitness score, and
said comparison of the first fitness score to the second fitness score;
said retraining when the comparison of the first fitness score to the second fitness score consists of said retraining when said comparison in a last iteration of the sequence of iterations indicates said data drift.

3. The method of claim 2 further comprising:
increasing, in said each iteration of the sequence of iterations, a respective size of at least one particular plurality of tuples selected from the group consisting of the first plurality of tuples and the second plurality of tuples;
ceasing the sequence of iterations when at least one selected from the group consisting of:
said size of the particular plurality of tuples is not less than a population of tuples from which the particular plurality of tuples is selected, and
said comparison of the first fitness score to the second fitness score indicates said data drift.

4. The method of claim 3 wherein said increasing the size of the particular plurality of tuples comprises one selected from the group consisting of an exponential increase and a super-exponential increase.

5. The method of claim 1 wherein:
said permuting the first plurality of tuples and the second plurality of tuples is repeated by an alternation count for one occurrence of said combining the first plurality of tuples and the second plurality of tuples;
the alternation count is experimentally predetermined by detecting a knee of a curve.

6. The method of claim 1 wherein:
the first fitness score is based on a plurality of scores;
said comparison of the first fitness score to the second fitness score comprises a comparison of the second fitness score to a threshold score;
the method further comprises calculating the threshold score based on the plurality of scores of the first fitness score.

7. The method of claim 1 wherein said machine learning model comprises at least one selected from the group consisting of:
an anomaly detector,
an opaque machine learning model,
an unsupervised learning model, and
a machine learning model based on a same machine learning algorithm as said binary classifier.

8. The method of claim 1 wherein:
said machine learning model is a classifier that infers a plurality of labels that does not include the first label and the second label;
a particular plurality of tuples comprises at least one selected from the group consisting of the first plurality of tuples and the second plurality of tuples;
before said combining the first plurality of tuples and the second plurality of tuples, at least one selected from the group consisting of:
the particular plurality of tuples is not assigned said plurality of labels, and
the classifier has not classified the particular plurality of tuples.

9. The method of claim 1 wherein said permuting the labels of the combined plurality of tuples comprises at least one selected from the group consisting of:
assigning the label of a tuple of the combined plurality of tuples to a different tuple of the permuted plurality of tuples,
preserving, in the permuted plurality of tuples, respective frequencies of the first label and the second label that occur in the combined plurality of tuples,
reassigning the label of a tuple of the permuted plurality of tuples to a randomly selected one of the first label and the second label, and
reassigning the label of a randomly selected tuple of the permuted plurality of tuples to a different label.

10. The method of claim 1 wherein at least one selected from the group consisting of:
said measuring the first fitness score entails cross validation, and
said measuring the second fitness score entails cross validation.

11. The method of claim 1 wherein:
said retraining the machine learning model entails at least the second plurality of tuples;
at least one selected from the group consisting of:
the first plurality of tuples is older than the second plurality of tuples, and
the first plurality of tuples is larger than the second plurality of tuples.

12. The method of claim 1 wherein:
the first fitness score is a first plurality of scores;
the second fitness score is a second plurality of scores;
said comparison of the first fitness score to the second fitness score comprises at least one selected from the group consisting of:
detecting that an average of the second plurality of scores falls within a particular quantile of the first plurality of scores, and
performing a t-test.

13. The method of claim 1 further comprising at least one selected from the group consisting of:
training the binary classifier with the combined plurality of tuples, and
training the binary classifier with the permuted plurality of tuples.

14. The method of claim 1 wherein the machine learning model accepts as input at least one selected from the group consisting of:
a categorical feature,
an integer feature having fewer than a thousand possible values,
an integer feature having a range that includes a gap, and
an integer feature having a range that includes unrelated values.

15. The method of claim 1 wherein:
the machine learning model accepts a plurality of features as input;
said data drift is based on at least one selected from the group consisting of:
a first feature of the plurality of features that is correlated with a second feature of the plurality of features, and
more than one feature of the plurality of features.

16. A method comprising:
randomly selecting:
a first subset of a first plurality of tuples,
a second subset of the first plurality of tuples that is larger than the first subset of the first plurality of tuples, and
a subset, which is a same size as the first subset of the first plurality of tuples, of a second plurality of tuples;
combining:
the first subset of the first plurality of tuples and the second subset of the first plurality of tuples into a first combined plurality of tuples, and
the subset of the second plurality of tuples and the second subset of the first plurality of tuples into a second combined plurality of tuples;
measuring:
a first outlier score of an anomaly detector that infers, respectively for each tuple in the first combined plurality of tuples, an outlier score that indicates whether the tuple is anomalous, and
a second outlier score of the anomaly detector that infers, respectively for each tuple in the second combined plurality of tuples an outlier score that indicates whether the tuple is anomalous;
retraining a machine learning model when a comparison of the first outlier score to the second outlier score indicates data drift.

17. A method comprising:
repeatedly:
a) selecting, based on respective probabilities of a first plurality of tuples and a second plurality of tuples, a particular plurality of tuples selected from the group consisting of the first plurality of tuples and the second plurality of tuples;
b) randomly selecting:
a subset of the particular plurality of tuples, and
a subset of the first plurality of tuples that is larger than the subset of the particular plurality of tuples;
c) combining the subset of the particular plurality of tuples and the subset of the first plurality of tuples into a combined plurality of tuples;
d) measuring an average outlier score of the combined plurality of tuples; and
e) adjusting, based on the average outlier score of the combined plurality of tuples, said probability of the particular plurality of tuples;
retraining a machine learning model when said probability of the second plurality of tuples indicates data drift.

18. The method of claim 17 further comprising ceasing said repeatedly based on said probability(s) of at least one selected from the group consisting of the first plurality of tuples and the second plurality of tuples.

19. One or more non-transitory computer-readable media storing instructions that, when executed by one or more processors, cause:
assigning:
to each tuple in a first plurality of tuples, a first label that indicates the first plurality of tuples, and
to each tuple in a second plurality of tuples, a second label that indicates the second plurality of tuples;
combining the first plurality of tuples and the second plurality of tuples into a combined plurality of tuples;
permuting the labels of the combined plurality of tuples to generate a permuted plurality of tuples;
measuring:
a first fitness score of a binary classifier that infers, respectively for each tuple in the combined plurality of tuples, the first label that indicates the first plurality of tuples or the second label that indicates the second plurality of tuples, and
a second fitness score of the binary classifier that infers, respectively for each tuple in the permuted plurality of tuples, the first label that indicates the first plurality of tuples or the second label that indicates the second plurality of tuples;
retraining a machine learning model when a comparison of the first fitness score to the second fitness score indicates data drift.

20. One or more non-transitory computer-readable media storing instructions that, when executed by one or more processors, cause:
randomly selecting:
a first subset of a first plurality of tuples,
a second subset of the first plurality of tuples that is larger than the first subset of the first plurality of tuples, and
a subset, which is a same size as the first subset of the first plurality of tuples, of a second plurality of tuples;
combining:
the first subset of the first plurality of tuples and the second subset of the first plurality of tuples into a first combined plurality of tuples, and
the subset of the second plurality of tuples and the second subset of the first plurality of tuples into a second combined plurality of tuples;
measuring:
a first outlier score of an anomaly detector that infers, respectively for each tuple in the first combined plurality of tuples, an outlier score that indicates whether the tuple is anomalous, and
a second outlier score of the anomaly detector that infers, respectively for each tuple in the second combined plurality of tuples an outlier score that indicates whether the tuple is anomalous;
retraining a machine learning model when a comparison of the first outlier score to the second outlier score indicates data drift.

21. One or more non-transitory computer-readable media storing instructions that, when executed by one or more processors, cause:
repeatedly:
a) selecting, based on respective probabilities of a first plurality of tuples and a second plurality of tuples, a particular plurality of tuples selected from the group consisting of the first plurality of tuples and the second plurality of tuples;
b) randomly selecting:
a subset of the particular plurality of tuples, and
a subset of the first plurality of tuples that is larger than the subset of the particular plurality of tuples;
c) combining the subset of the particular plurality of tuples and the subset of the first plurality of tuples into a combined plurality of tuples;
d) measuring an average outlier score of the combined plurality of tuples; and
e) adjusting, based on the average outlier score of the combined plurality of tuples, said probability of the particular plurality of tuples;
retraining a machine learning model when said probability of the second plurality of tuples indicates data drift.
